(19) United States
(12) Patent Application Publication
(10) Pub. No.: US 2026/0361378 A1
(43) Pub. Date: Nov. 12, 2026

(54) NETWORK NODE INFORMATION UPDATES SHARING WITH UE OR UE-SIDE SERVER

(71) Applicant: QUALCOMM Incorporated, San Diego, CA (US)

(72) Inventors: Rajeev KUMAR, San Diego, CA (US); Aziz GHOLMIEH, Del Mar, CA (US); Hamed PEZESHKI, San Diego, CA (US); Punyaslok PURKAYASTHA, San Diego, CA (US)

(21) Appl. No.: 19/666,014

(22) Filed: May 1, 2026

Related U.S. Application Data
(60) Provisional application No. 63/801,032, filed on May 6, 2025.

(51) Int. Cl. H04B 7/06; H04L 41/16; H04W 36/30

(52) U.S. Cl. CPC H04B 7/06952; H04L 41/16; H04W 36/305

(57) ABSTRACT

A method for wireless communication at a user equipment (UE) and related apparatus are provided. In the method, the UE communicates with a server associated with the UE an update on network node information related to a communication functionality for wireless communication with a network entity. The network node information includes a set of identifiers for cells or beams associated with the network entity, and the update on the network node information originates from the network entity. The UE further communicates with the network entity based on the update on the network node information related to the communication functionality.

### CROSS REFERENCE TO RELATED APPLICATION(S)

This application claims the benefit of and priority to U.S. Provisional Application Ser. No. 63/801,032, entitled “NETWORK NODE INFORMATION UPDATES SHARING WITH UE OR UE-SIDE SERVER” and filed on May 6, 2025, which is expressly incorporated by reference herein in its entirety.

### TECHNICAL FIELD

The present disclosure relates generally to communication systems and, more particularly, to information sharing in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 6G, which is an enhancement of 5G New Radio (NR) and is a part of a continuous mobile broadband evolution promulgated by Third Generation Partnership Project (3GPP) to meet new requirements associated with latency, reliability, security, scalability (e.g., with Internet of Things (IoT)), capacity, location services, energy efficiency, artificial intelligence (AI) integration, and other requirements. Some aspects of 6G may be based on the 5G NR and 4G Long Term Evolution (LTE). There exists a need for further improvements in 6G/5G technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to communicate, with a server associated with the UE, an update on network node information related to a communication functionality for wireless communication with a network entity, where the network node information includes a set of identifiers for cells or beams associated with the network entity, where the update on the network node information originates from the network entity; and communicate with the network entity based on the update on the network node information related to the communication functionality.

In an aspect of the disclosure, a method, a computer-readable medium, and an apparatus are provided for wireless communication at a server associated with one or more UEs. The apparatus may include at least one memory and at least one processor coupled to the at least one memory. Based at least in part on information stored in the at least one memory, the at least one processor may be configured to receive, from a network entity or a first UE associated with the server, an update on network node information related to a communication functionality for communicating between the network entity and the first UE associated with the server, where the network node information includes a set of identifiers for cells or beams associated with the network entity, wherein the update on the network node information originates from a serving cell associated with the network entity; and transmit updated operational information related to the communication functionality, wherein the updated operational information is based on the update on the network node information.

In an aspect of the disclosure, a method, a computer-readable medium, and an apparatus are provided for wireless communication at a serving cell. The apparatus may include at least one memory and at least one processor coupled to the at least one memory. Based at least in part on information stored in the at least one memory, the at least one processor may be configured to transmit, to a first UE or a network entity associated with the serving cell, an update on network node information related to a communication functionality for communicating between the network entity and the first UE, where the network node information includes a set of identifiers for cells or beams associated with the network entity; and communicate with the first UE based on updated operational information related to the communication functionality. The updated operational information is based on the update on the network node information.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is an illustrative block diagram of an example machine learning (ML) model represented by an artificial neural network (ANN), in accordance with various aspects of the present disclosure.

FIG. 5 is a diagram illustrating an example of an artificial intelligence (AI) and machine learning (ML) (AI/ML) algorithm of a method of wireless communication.

FIG. 6A is a diagram illustrating an example of data sharing via a non-over-the-air (non-OTA) method.

FIG. 6B is a diagram illustrating an example of data sharing via an OTA method.

FIG. 7 is a diagram illustrating an example of network node information sharing via a non-OTA method in accordance with various aspects of the present disclosure.

FIG. 8 is a diagram illustrating another example of network node information sharing via an OTA method in accordance with various aspects of the present disclosure.

FIG. 9 is a call flow diagram illustrating a method of wireless communication in accordance with various aspects of the present disclosure.

FIG. 10 is a flowchart illustrating methods of wireless communication at a UE in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a server associated with one or more UEs in accordance with various aspects of the present disclosure.

FIG. 13 is a flowchart illustrating methods of wireless communication at a serving cell in accordance with various aspects of the present disclosure.

FIG. 14 is a diagram illustrating an example of a hardware implementation for an example apparatus and/or UE.

FIG. 15 is a diagram illustrating an example of a hardware implementation for an example network entity.

### DETAILED DESCRIPTION

In wireless communication, various models, such as artificial intelligence/machine learning (AI/ML) models may be implemented on user equipment (UE) or base stations to support tasks such as beam prediction, measurement event prediction, radio link failure (RLF) detection, and handover failure (HOF) prediction. These models enhance the efficiency and reliability of communication between the UE and the base station. To ensure the model's effectiveness, consistency between the training and inference phases of the model may be maintained. However, if the network changes one or more network node information (e.g., the physical cell identifiers (PCI) for measurement and prediction) without notifying the UE, this consistency may be violated. As a result, the performance of the model may deteriorate due to discrepancies between the training and inference environments. Example aspects presented herein provide methods and apparatus for sharing updated network node information with UE or UE-side servers, thereby ensuring consistency between the training and interference phases of a model.

Various aspects relate generally to wireless communication. Some aspects more specifically relate to the sharing of network node information in wireless communication. In some examples, a UE communicates with (receives from or transmits to) a server associated with the UE an update on network node information related to a communication functionality for wireless communication with a network entity. The network node information may include a set of identifiers for cells or beams associated with the network entity, and the update on the network node information originates from the network entity. The UE further communicates with the network entity based on the update on the network node information related to the communication functionality. In some examples, the network node information may include one or more of: a first set of cell identifiers for the cells associated with the network entity, a second set of beam identifiers for the beams associated with the network entity, or a third set of associated identifiers for network-side conditions for the communication functionality. In some examples, the communication functionality may include one or more of: the spatial domain beam prediction, the temporal domain beam prediction, the measurement event prediction, the radio link failure (RLF) prediction, or the handover failure (HOF) prediction. In some examples, the communication functionality may be associated with an AI/ML model, and the update on the network node information may include the update on the network node information from first network node information associated with the training of the AI/ML model for the communication functionality to second network node information associated with the inference of the AI/ML model for the communication functionality.

Particular aspects of the subject matter described in this disclosure can be implemented to realize one or more of the following potential advantages. In some examples, by enabling the sharing of updated network node information, such as PCI, beam index, and associated IDs, from the network to the UE or UE-side servers, the described techniques ensure consistency between the training and inference phases of a model used in wireless communication systems, thereby ensuring model reliability, robustness, and adaptability in dynamic network environments. In some examples, by enabling a model update propagation mechanism from a single UE to other associated UEs via a UE-side server, the described techniques enhance efficiency and reduce overhead on individual UEs while maintaining consistency across devices.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, 6G systems, or other communication systems, may be arranged in multiple manners with various components or constituent parts. As an example, in a wireless communication network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, 6G NB, 6G RAN, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

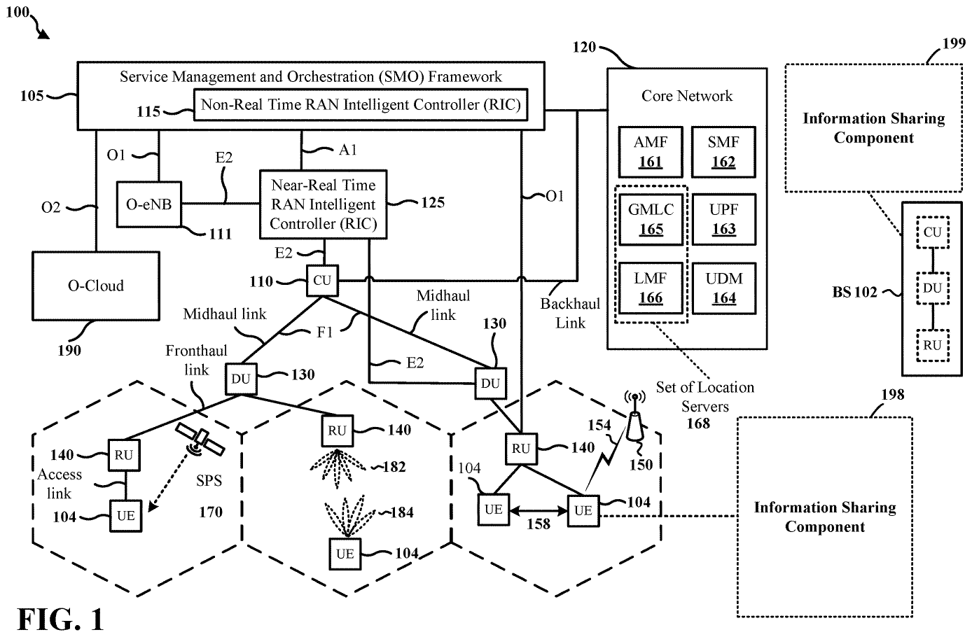

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. As an example, two initial operating bands have been identified as frequency range designations FR1 (410 MHz-7.125 GHz) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. An operating band for these mid-band frequencies may have the frequency range designation FR3 (7.125 GHZ-24.25 GHZ), for example. Frequency bands falling within FR3 may inherit FR1 characteristics and/or FR2 characteristics, and thus may effectively extend features of FR1 and/or FR2 into mid-band frequencies. In addition, higher frequency bands are currently being explored to extend wireless communication operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the information sharing component 198. The information sharing component 198 may be configured to communicate, with a server associated with the UE, an update on network node information related to a communication functionality for wireless communication with a network entity, where the network node information includes a set of identifiers for cells or beams associated with the network entity, where the update on the network node information originates from the network entity; and communicate with the network entity based on the update on the network node information related to the communication functionality. In certain aspects, the base station 102 may include the information sharing component 199. The information sharing component 199 may be configured to transmit, to a first UE or a network entity associated with the serving cell, an update on network node information related to a communication functionality for communicating between the network entity and the first UE, where the network node information includes a set of identifiers for cells or beams associated with the network entity; and communicate with the first UE based on updated operational information related to the communication functionality. The updated operational information is based on the update on the network node information. Although the following description may give examples based on 5G NR to illustrate concepts relating to wireless communication, the concepts described herein may be applicable to other similar areas, such as LTE, LTE-A, CDMA, GSM, 6G and other wireless technologies.

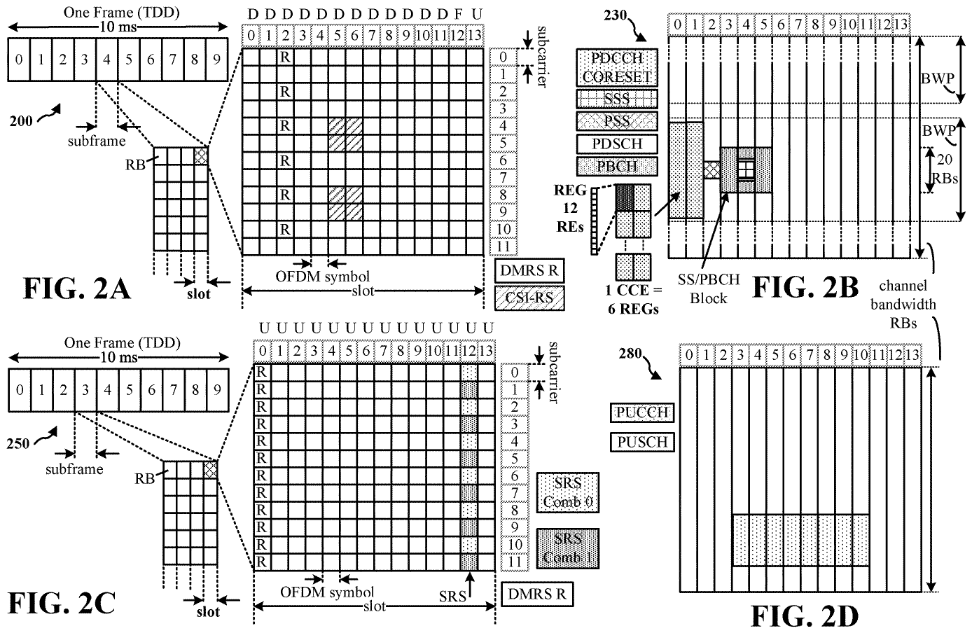

FIG. 2A is a diagram 200 illustrating an example of a first subframe within a frame structure. FIG. 2B is a diagram 230 illustrating an example of DL channels within a subframe. FIG. 2C is a diagram 250 illustrating an example of a second subframe within a frame structure. FIG. 2D is a diagram 280 illustrating an example of UL channels within a subframe. The examples in FIGS. 2A-2D show example aspects of a frame structure based on 5G NR to illustrate the concept of a frame structure and wireless communication based on a frame structure. Various aspects described in connection with FIGS. 2A-2D may also be used in connection with other wireless communication technologies, such as 6G among other examples. The frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

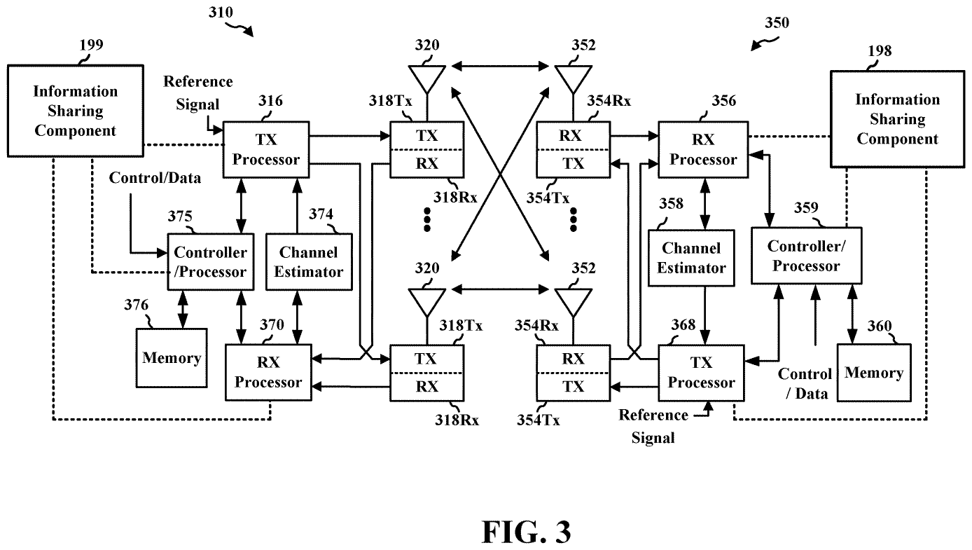

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the information sharing component 198 of FIG. 1.

At least one of the TX processor 316, the RX processor 370, and the controller/processor 375 may be configured to perform aspects in connection with the information sharing component 199 of FIG. 1.

Some aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets that may indicate a starting point for the outputs of the ML model. An example ML model operating on input data may start at an initial output based on the biases and then update its output based on a combination of the input data and the weights.

In some aspects, an ML model, also referred to as an AI/ML model in some aspects, may be configured to provide computing capabilities for wireless communications. Such an ML model may be configured with weights and biases to perform various tasks (e.g., spatial and temporal beam prediction, measurement event prediction, RLF detection, and HOF prediction). Thus, during the operation of a device, the ML model may receive input data (such as criteria used for beam prediction (such as measurements on a set of beams, among other examples) and make inferences (e.g., predicting beams) based on the weights and biases. Beam prediction is merely one example of a functionality for an ML model. In other examples, the ML model may be trained for other tasks, such as CSI prediction, CSI compression/decompression, interference prediction, positioning, sensing, scheduling and resource selection, and/or reference signal design and optimization, among other examples.

ML models may be deployed in one or more devices (for example, network entities and UE) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc.

ML models may be characterized in terms of the types of learning that generate specific types of learned models that perform specific types of tasks. For example, different types of machine learning include supervised learning, unsupervised learning, semi-supervised learning, reinforcement learning, deep learning, etc. ML models may be used to perform different tasks, such as classification or regression, where classification refers to determining one or more discrete output values from a set of predefined output values, and regression refers to determining continuous values that are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some examples, how one or more tasks or problems in wireless communications may benefit from the application of one or more ML models for the prediction of one or more channel characteristics associated with a second set of resources using measurement of the aperiodic reference signal on a first set of resources based on a first mapping pattern. The first mapping pattern maps the first set of resources to the second set of resources, and the first mapping pattern and a second mapping pattern associated with an initial training meet one or more of a spatial domain consistency condition or a temporal domain consistency condition. To facilitate the discussion, an ML model configured using an ANN is used, but other types of ML models may be used instead of an ANN. Hence, unless expressly recited, subject matter regarding an ML model is not intended to be limited to an ANN solution. Unless otherwise specifically stated, terms such as “AI/ML model,” “ML model,” “trained ML model,” “ANN,” “model,” “algorithm,” or the like are intended to be interchangeable.

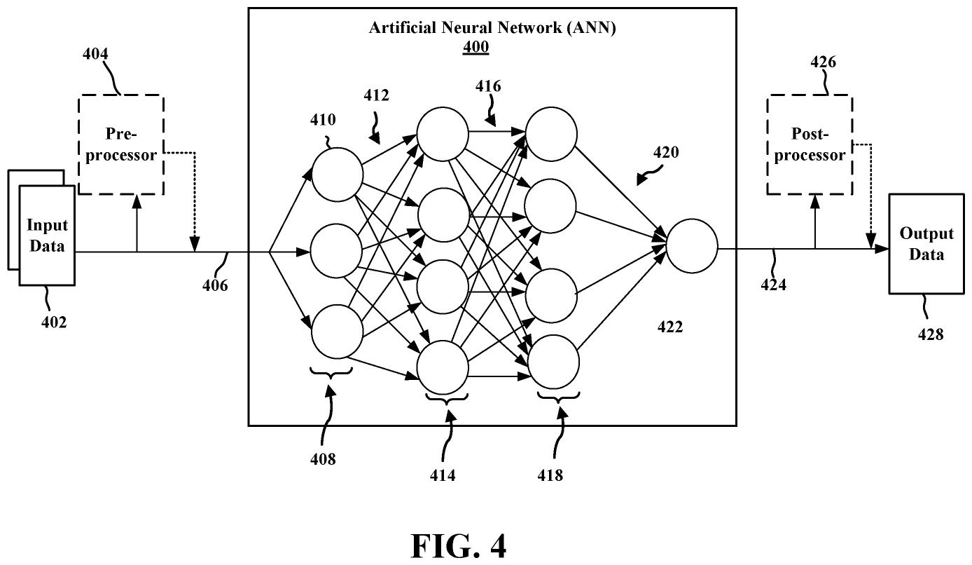

FIG. 4 is an illustrative block diagram of an example machine learning (ML) model represented by an artificial neural network (ANN) 400. ANN 400 may receive input data 406, which may include one or more bits of data 402, pre-processed data output from pre-processor 404 (optional), or some combination thereof. Here, data 402 may include training data, verification data, application-related data, or the like, based, for example, on the stage of deployment of ANN 400. Pre-processor 404 may be included within ANN 400 in some other implementations. Pre-processor 404 may, for example, process all or a portion of data 402, which may result in some of data 402 being changed, replaced, deleted, etc. In some implementations, pre-processor 404 may add additional data to data 402. In some implementations, the pre-processor 404 may be an ML model, such as an ANN. As an example, the input for traffic classification may include traffic information or traffic pattern information. In other examples, the input may be different. For example, for beam prediction, the input may be measurements performed on a set-B of beams. For CSI prediction, compression, or decompression, the input may include one or more CSI measurements. For a model trained for interference prediction, the input may include one or more interference measurements, or other information that may enable the model to predict interference. For positioning, sensing, scheduling and resource selection, and/or reference signal design and optimization, the input may be different.

The ANN 400 includes at least one first layer 408 of artificial neurons 410 to process input data 406 and provide resulting first layer data via connections or “edges” such as edges 412 to at least a portion of at least one second layer 414. Second layer 414 processes data received via edges 412 and provides second layer output data via edges 416 to at least a portion of at least one third layer 418. Third layer 418 processes data received via edges 416 and provides third layer output data via edges 420 to at least a portion of a final layer 422, including one or more neurons to provide output data 424. All or part of output data 424 may be further processed in some manner by (optional) post-processor 426. Thus, in certain examples, ANN 400 may provide output data 428 that is based on output data 424, post-processed data output from post-processor 426, or some combination thereof. In an example where the ML model is used to classify traffic, the output may include an inference of a traffic type. In examples where the ML model is used for beam prediction, the output may include a set of resource (e.g., beam) predictions for Set-A beams. A base station or UE may then select a beam for use in transmission and/or reception based on the beam predictions for the Set-A beams output from the AI/ML model. In an ML model trained for CSI prediction, the output may be a predicted CSI measurement that may be used for future communication. For CSI compression, the input may be the CSI to be reported, and the output may include a compressed CSI that can be signaled using reduced overhead. For CSI decompression, the input may be a compressed CSI based on a corresponding model, and the output may be a decompressed CSI with the original CSI prior to compression. For interference prediction, the output may be a prediction of interference for one or more resources. For positioning, the output may be a position prediction. For scheduling and resource selection, the output may be an indication of resources that will allow for more accurate communication and/or more efficient scheduling. For reference signal design and optimization, the output may identify a reference signal or one or more parameters for a reference signal for use by a UE or a network.

Post-processor 426 may be included within ANN 400 in some other implementations. Post-processor 426 may, for example, process all or a portion of output data 424, which may result in output data 428 being different, at least in part, from output data 424, as a result of data being changed, replaced, deleted, etc. In some implementations, post-processor 426 may be configured to add additional data to output data 424. In this example, second layer 414 and third layer 418 represent intermediate or hidden layers that may be arranged in a hierarchical or other like structure. Although not explicitly shown, there may be one or more further intermediate layers between the second layer 414 and the third layer 418. In some implementations, the post-processor 426 may be an ML model, such as an ANN.

The structure and training of artificial neurons 410 in the various layers may be tailored to the specific requirements of an application. Within a given layer, such as first layer 408, second layer 414, or third layer 418 of ANN 400, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” the artificial neurons of the next layer. Artificial neurons in such a layer may be activated by or be responsive to parameters such as the previously described weights and biases of ANN 400. The weights and biases of ANN 400 may be adjusted during a training process or during the operation of ANN 400. The weights of the various artificial neurons may control the strength of connections between layers or artificial neurons, while the biases may control the direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 406. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 400, may be conducted using training data. Training data may include one or more datasets that ANN 400 may use to identify patterns or relationships. Training data may represent various types of information, including written, visual, audio, environmental context, operational properties, etc. During training, the parameters (such as the weights and biases) of artificial neurons 410 may be changed, such as to minimize or otherwise reduce a loss function or a cost function. A training process may be repeated multiple times to fine-tune ANN 400 with each iteration.

Various ANN model structures are available for consideration. For example, in a feedforward ANN structure, each artificial neuron 410 in layer 414 receives information from the previous layer (such as one or more artificial neurons 410 in layer 408) and produces information for the next layer (such as one or more artificial neurons 410 in layer 418). In a convolutional ANN structure, some layers may be organized into filters that extract features from data, such as the training data or the input data. In a recurrent ANN structure, some layers may have connections that allow for the processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feedforward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing.

Another example type of ANN structure is a model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks.

ANN 400 or other ML models may be implemented in various types of processing circuits along with memory and applicable instructions therein. For example, general-purpose hardware circuits, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by an NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to an RF transceiver based on the outputs or inferences obtained from an ML model to cause the RF transceiver to operate on a wireless network in accordance with the ML model.

In some examples, an ML model may be trained prior to, or at some point following, the operation of the ML model, such as ANN 400, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). For example, wireless network architectures, such as self-organizing networks (SON) or mobile drive test (MDT) networks, may be adapted to support the collection of data for ML model applications. In another example, training data may be generated or collected online, offline, or both online and offline by a UE, network entity, or other device(s), and all or part of such training data may be transferred or shared (in real or near-real time), such as through store and forward functions or the like.

Offline training may refer to creating and using a static training dataset, such as in a batched manner, whereas online training may refer to the real-time collection and use of training data. For example, an ML model at a network device (such as a UE) may be trained or fine-tuned using online or offline training. For offline training, data collection and training can occur in an offline manner at the network side (such as at a base station or other network entity) or at the UE side. For online training, the training of a UE-side ML model may be performed locally at the UE or by a server device (such as a server hosted by a UE vendor) in a real-time or near-real-time manner based on data provided to the server device from the UE. In certain instances, all or part of the training data may be shared within a wireless communication system or even shared (or obtained from) outside of the wireless communication system.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, retraining it on the data, or using different optimization techniques, etc.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in a training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases to reduce or minimize the loss function, which can improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust the learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an ongoing training process early, such as when the performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve the efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that is transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment and less aggressively prune the model for use in a high-power or high-bandwidth environment. In certain example implementations, pruning techniques may also be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting or otherwise improve the performance of the trained model.

One or more of the example training techniques presented above may be employed as part of a training process. Some example training processes that may be used to train an ANN include supervised learning, unsupervised learning, semi-supervised learning, and reinforcement learning techniques. With supervised learning, a model is trained on a labeled training dataset, where the input data is accompanied by a correct or otherwise acceptable output. With unsupervised learning, a model is trained on an unlabeled training dataset, such that the model will learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize the behavior of a model deployed in a dynamically changing environment, such as a wireless communication network. Distributed, shared, or collaborative learning techniques may be used for the training process. For example, techniques such as federated learning may be used to decentralize the training process and rely on multiple devices, network entities, or organizations for training various versions or copies of an ML model without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a UE or other device may receive a copy of all or part of a global or shared model and perform local training on the local model using locally available training data. The UE may provide updated information regarding the locally trained model to one or more other devices (such as a network entity or a server), where the updates from other-like devices (such as other UEs) may be aggregated and used to provide an update to the global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to an ML model's usage, maintenance, activation, reporting, or the like. In certain instances, all or part of a dataset or model may be shared across multiple devices to provide or otherwise augment or improve processing. In some examples, signaling mechanisms may be utilized at various nodes of wireless networks to signal the capabilities for performing specific functions related to ML models, support for specific ML models, capabilities for gathering, creating, and transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as a UE, a network entity such as a base station, or a disaggregated network entity such as a central unit (CU), a distributed unit (DU), a radio unit (RU), or the like.

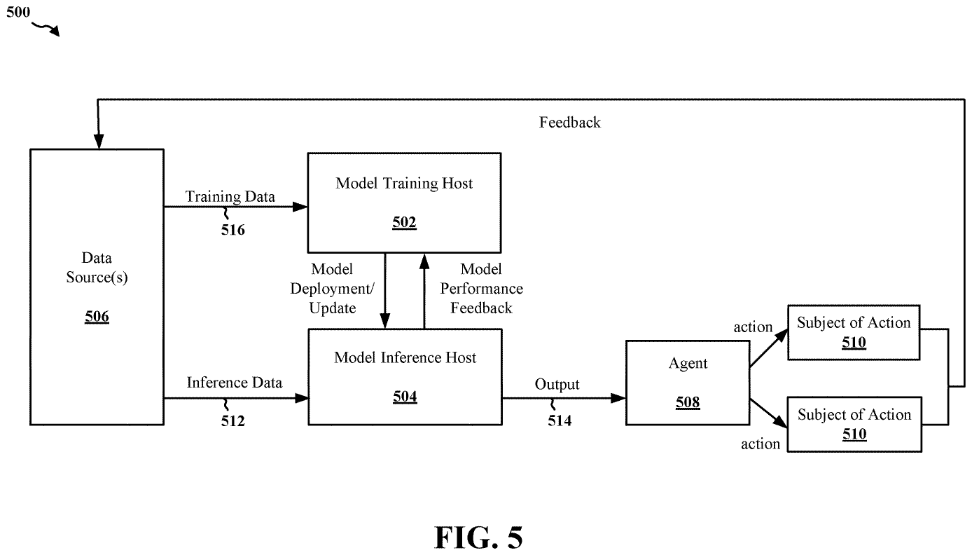

FIG. 5 is an illustrative block diagram of an example ML architecture 500 that may be used for wireless communications in any of the various implementations, processes, environments, networks, or use cases listed above. As illustrated, architecture 500 includes multiple logical entities, such as model training host 502, model inference host 504, data source(s) 506, and agent 508. Model inference host 504 is configured to run an ML model based on inference data 512 provided by data source(s) 506. Model inference host 504 may produce output 514, which may include a prediction or inference, such as a discrete or continuous value based on inference data 512, which may then be provided as input to the agent 508.

Agent 508 may represent an element or an entity of a wireless communication system including, for example, a radio access network (RAN), a wireless local area network, a device-to-device (D2D) communications system, etc. As an example, agent 508 may be a user equipment (such as UE 104, referring to FIG. 1, for example), a base station (such as base station 102, referring to FIG. 1, for example), or a disaggregated network entity (such as a CU 110, DU 130, or RU 140 in FIG. 1), an access point, a wireless station, a RAN intelligent controller (RIC) in a cloud-based RAN, among some examples. Additionally, agent 508 may also be a type of agent that depends on the type of tasks performed by model inference host 504, the type of inference data 512 provided to model inference host 504, or the type of output 514 produced by model inference host 504. As an example, for beam prediction, the input may be measurement results from a set of beams (e.g., Set B), and the output may include beam prediction for another set of beams (e.g., Set A). A base station or UE may then communicate based on the beam predictions output from the AI/ML model.

Agent 508 may perform one or more actions associated with receiving output 514 from model inference host 504, e.g., selection, use, and/or reporting regarding the inferences made for the different set of resources (e.g., traffic classification). Agent 508 may indicate the one or more actions performed to at least one subject of action 510. In some cases, agent 508 and the subject of action 510 are the same entity.

Data can be collected from data sources 506, and may be used as training data 516 for training an ML model, or as inference data 512 for feeding an ML model inference operation. Data sources 506 may collect data from various subject of action 510 entities (such as the UE or the network entity) and provide the collected data to a model training host 502 for ML model training. In some examples, if output 514 provided to agent 508 is inaccurate (or the accuracy is below an accuracy threshold), model training host 502 may provide feedback to model inference host 504 to modify or retrain the ML model used by model inference host 504, such as via an ML model deployment update.

Model training host 502 may be deployed at the same or a different entity than that in which model inference host 504 is deployed. For example, in order to offload model training processing, which can impact the performance of model inference host 504, model training host 502 may be deployed at a model server.

As computational models, including AI/ML models or functionalities (e.g., the AI/ML model including any of the aspects described in connection with the ANN 400 or the ML architecture 500) are increasingly utilized for various tasks in wireless communication, a UE may have multiple models (e.g., AI/ML models) trained for a variety of different tasks and use cases, such as traffic classification, interference prediction, beam prediction, CSI prediction, CSI compression, and/or positioning. However, UEs are constrained by limited computational, memory, and power resources, which are shared among these models (e.g., AI/ML models). As a result, UEs may not be able to operate all requested models or functionalities simultaneously. Example aspects presented herein provide methods and apparatus to configure UEs for scenarios where multiple tasks (e.g., AI/ML tasks) are scheduled to be performed despite the limitations in memory, compute, and other resources.

AI/ML models (e.g., the AI/ML model including any of the aspects described in connection with the ANN 400 or the ML architecture 500) can be adapted for use in various wireless communication scenarios due to their ability to provide significant performance enhancements. These models can leverage vast amounts of historical data to improve performance compared to various baselines. For example, AI/ML models can handle the high-dimensional features inherent in wireless environments, such as signal strength, beamforming patterns, and interference levels. Additionally, AI/ML models can capture the nonlinearities and dynamic conditions of wireless networks that analytical models often fail to comprehend. This capability leads to improved predictions of network behavior and more efficient allocation of radio resources.

AI/ML models can provide remarkable success in numerous wireless use cases. These include traffic classification, CSI prediction and compression, interference prediction, beam prediction, positioning and sensing, scheduling and resource selection, and reference signal design and optimization, among others. For example, the use cases of AI/ML models (e.g., the AI/ML model including any of the aspects described in connection with the ANN 400 or the ML architecture 500) may include enhancements in traffic management (e.g., with improved traffic classification), CSI feedback, beam management, and/or positioning accuracy. For CSI feedback enhancement, this may involve spatial-frequency domain CSI compression using AI/ML models deployed on both sides of the communication link, and time-domain CSI prediction utilizing models on the UE side. For beam management, use cases of AI/ML models may include spatial-domain downlink beam prediction for a first set of beams (e.g., Set A) based on measurement results from a second set of beams (e.g., Set B), and temporal downlink beam prediction for Set A beams based on the historical measurement results of Set B beams. For positioning accuracy enhancement, use cases of AI/ML models include direct AI/ML-based positioning and AI/ML-assisted positioning, as an example.

The adoption of AI/ML models (e.g., the AI/ML model including any of the aspects described in connection with the ANN 400 or the ML architecture 500) may use AI/ML model terminology and descriptions to identify common and specific characteristics for framework investigation. This includes characterizing the defining stages of AI/ML-related algorithms and associated complexities, identifying various levels of collaboration between the UE and network relevant to the selected use cases, and characterizing the lifecycle management of AI/ML models, among others.

In some examples, an AI/ML models (e.g., the AI/ML model including any of the aspects described in connection with the ANN 400 or the ML architecture 500) may be used for spatial and temporal beam prediction. For example, in spatial downlink beam prediction, an AI/ML model may predict measurements for a set of beams (e.g., Set A beams) based on the measurement results of another set of beams (e.g., Set B beams). In some examples, Set B beams may be wide beams (e.g., synchronization signal block (SSB) beams), while Set A beams may be narrow beams (e.g., channel state information reference signal (CSI-RS) beams). In some examples, Set B may be narrow beams, and Set A beams may be other narrow beams. For example, in temporal downlink beam prediction, an AI/ML model may predict measurements for a set of beams (e.g., Set A beams) based on historic measurement results of another set of beams (e.g., Set B beams). In some examples, Set A beams and Set B beams may be identical, representing a temporal beam prediction. In some examples, Set A beams and Set B beams may be different, representing a combination of spatial and temporal beam prediction.

In some examples, an AI/ML model may be used for mobility prediction. In some examples, mobility prediction may be considered as a cell level measurement prediction, which is an extension of the beam level measurement prediction to serving and candidate cells. The models used in this prediction may be UE-side or network-side models. In some examples, an AI/ML model may be used for measurement events prediction, RLF detection (or prediction), or handover failure (HOF) prediction.

To ensure the effectiveness of a model (e.g., the AI/ML model including any of the aspects described in connection with the ANN 400 or the ML architecture 500), consistency between the training and inference phases of the model may be maintained. As used herein, the “consistency between the training and inference phases of the model” refers to the alignment of data characteristics, network or device conditions, and assumptions between the model's training stage and inference stage. For example, this consistency may include maintaining identical mappings of cell identifiers (IDs) and corresponding cells, beam indices and their corresponding beams between the training and inference phases of the model.

In some examples, an associated ID may be used to represent the network-side additional conditions, such as the codebook used at the radio access network (RAN), the antenna pattern, and other similar parameters. The associated ID may help align the conditions under which the model is trained with those under which it is later used for inference.

In some examples, when an AI/ML model (e.g., the AI/ML model including any of the aspects described in connection with the ANN 400 or the ML architecture 500) is used to predict mobility, the network may share either complete layout information or pairwise layout information to maintain the consistency between training and inference phases. For example, the complete layout information may include the relationship between a cell and all of its neighboring cells, provided as an ID or as explicit information. For example, pairwise layout information may include the relationship between a cell and each of its neighboring cells individually, provided as an ID or as explicit information. In some examples, a cluster ID may be used to maintain the consistency between training and inference phases, for example, when clustering-based training and inference methods are used.

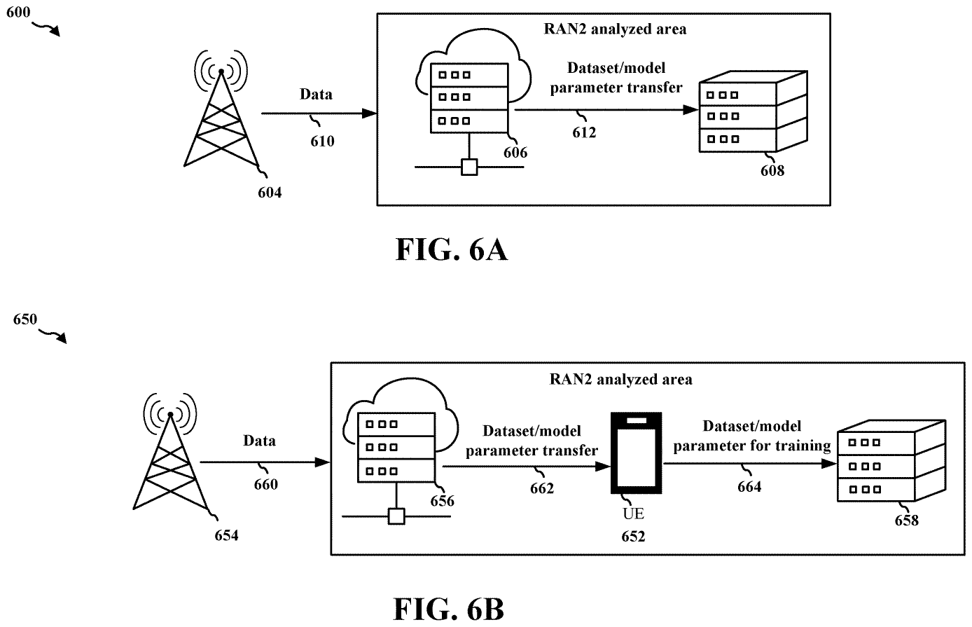

In some examples, dataset and model parameter sharing may be implemented in various ways. In some examples, the dataset and model parameter sharing may be implemented using a non-over-the-air (non-OTA) method. FIG. 6A is a diagram 600 illustrating an example of data sharing via a non-OTA method. As shown in FIG. 6A, in the non-OTA method, a base station 604 may first transfer data (e.g., via 610) to a network-side dataset or model parameters collection entity 606. For example, the network-side dataset or model parameters collection entity 606 may be another base station, a core network (CN), or an operations, administration, and maintenance (OAM) entity. Then, the network-side dataset or model parameters collection entity 606 may forward, via 612, the information (e.g., dataset or model parameters) to a UE-side training entity 608. For example, the UE-side training entity 608 may be a server located within a mobile network operator (MNO) infrastructure or an over-the-top (OTT) server.

In some examples, the dataset and model parameter sharing may be implemented using an over-the-air (OTA) method. FIG. 6B is a diagram 650 illustrating an example of data sharing via an OTA method. As shown in FIG. 6B, in the OTA method, a base station 654 may first transfer data (e.g., via 660) to a network-side dataset or model parameters collection entity 656. For example, the network-side dataset or model parameters collection entity 656 may be another base station, a CN, or an OAM entity. In some examples, if needed, the network-side dataset or model parameters collection entity 656 may transfer the data to another base station. In some examples, the network-side dataset or model parameters collection entity 656 may transmit the information (e.g., dataset or model parameters) to the UE 652 via 662. The UE 652 then forwards the information (e.g., dataset or model parameters) to the UE-side training entity 658 via 664. Similar to the non-OTA method, the UE-side training entity 658 may be a server within the MNO or an OTT server.

In some examples, the consistency between training and inference phases of a model may be violated if the network changes one or more network node information and the UE-side is not informed about it. For example, assuming that during the data collection phase (or training phase), the UE is configured with one or more physical cell identifiers (PCI) for measurement and one or more PCI for prediction. If, after the data collection phase (or training phase), the network node changes the PCIs of one or more cells, then during the inference phase, when the UE receives one or more new PCIs for measurement and one or more new PCIs for prediction, the UE may not know correctly identify the cells to measure and the cells to predict (unless the UE is provided with a mapping between the old and new node information). Example aspects presented herein provide methods and apparatus for sharing updated network node information with UE or UE-side servers, thereby ensuring consistency between the training and interference phases of a model. Some example aspects provide procedures for the network-side to share updates regarding network node information with the UE-side. In some examples, the network node information to be updated may include one or more PCI values of the cells, one or more beam index values such as the SSB index or the CSI-RS beam identifier, one or more associated IDs, and other relevant information necessary to ensure consistency between training and inference phases.

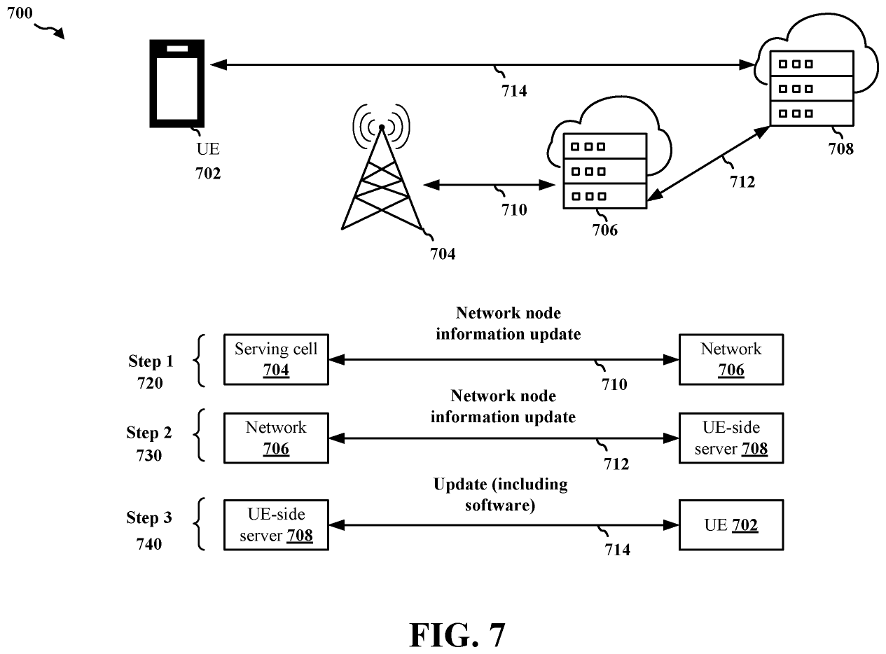

In some aspects, the sharing of the network node information update may be implemented using a non-OTA method. FIG. 7 is a diagram 700 illustrating an example of network node information sharing via a non-OTA method in accordance with various aspects of the present disclosure. As shown in FIG. 7, in the non-OTA method, the process begins (e.g., at step 1 720) with the serving cell (e.g., base station 704) of the network entity communicating network node information to the network entity 706 via 710. For example, the network node information may include information associated with the network node or network node properties. For example, the network node information may include cell-specific information (e.g., PCIs), beam-specific information (e.g., beam index values), and associated IDs. For example, the network entity 706 may be another base station, an OAM entity, a cloud-native network function (CNF), or a RAN intelligent controller (RIC). Then, at step 2 730, the network entity 706 may transmit the same network node information (e.g., PCIs, beam index values, and associated IDs) to a UE-side server 708 (e.g., via 712) that is associated with the UE 702. For example, the UE-side server 708 may be an OTT device associated with the UE 702, an application function (AF) associated with the UE 702, a non-real-time application (rApp) associated with the UE 702, or a near-real-time application (xApp) associated with the UE 702.

At step 3 740, the UE-side server 708 may then proceed to update the meta information for the model associated with the UE 702. For example, the model may be an AI/ML model including any of the aspects described in connection with the ANN 400 or the ML architecture 500. In some examples, the UE-side server 708 may perform software updates for the model as necessary. Once the meta information has been updated, the UE-side server 708 may, via 714, transmit this updated information to the associated UEs (e.g., UE 702). In this non-OTA method, the base station 704 may provide updates on the network node information (e.g., PCIs, beam index values, and associated IDs) to the network entity 706 for example. The network entity 706 may send these updates to the UE-side server 708, which then updates the meta information of the model accordingly and further updates the meta information for the models used by the UEs (e.g., UE 702).

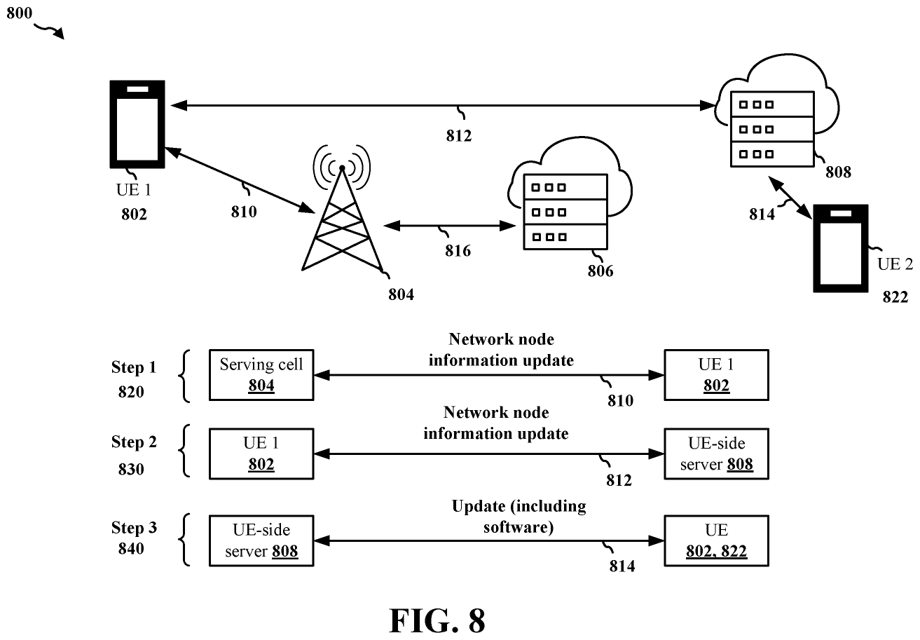

In some aspects, the sharing of the network node information update may be implemented using an OTA method. FIG. 8 is a diagram 800 illustrating an example of network node information sharing via an OTA method in accordance with various aspects of the present disclosure. As shown in FIG. 8, in the OTA method, the process begins (e.g., at step 1 820) with the base station 804 (e.g., a serving cell) communicating network node information to the UE (e.g., UE 1 802) via 810. For example, the network node information may include information associated with the network node or network node properties. For example, the network node information may include cell-specific information (e.g., PCIs), beam-specific information (e.g., beam index values), and associated IDs. After receiving the network node information, at step 2 830, the UE (e.g., UE 1 802) then communicates (e.g., via 812) the network node information (e.g., PCIs, beam index values, and associated IDs) to a UE-side server 808 associated with the UE (e.g., UE 1 802). For example, the UE-side server 808 may be an OTT device associated with the UE (e.g., UE 1 802), an AF associated with the UE (e.g., UE 1 802), an rApp associated with the UE (e.g., UE 1 802), or an xApp associated with the UE (e.g., UE 1 802).

At step 3 840, the UE-side server 808 may proceed to update the meta information for the model associated with the UE (e.g., UE 1 802). For example, the model may be an AI/ML model including any of the aspects described in connection with the ANN 400 or the ML architecture 500. In some examples, the UE-side server 808 may perform a software update for the model as necessary. Once updated, the UE-side server 808 may transmit the revised meta information to one or more UEs (e.g., UE 1 802 via 812, UE 2 822 via 814) associated with the UE-side server 808. In this OTA method, the base station 804 provides the update directly to the UE (e.g., UE 1 802 via 810). For example, the base station 804 may provide the update directly to the UE (e.g., UE 1 802 via 810) during the configuration of the inference at the UE (e.g., UE 1 802), enabling the UE to use the received information locally for the inference. In some examples, if configured, the UE (e.g., UE 1 802) may further provide the network information updates to the UE-side server 808 (e.g., via 812). The UE-side server 808 then updates the meta information of the model and ensures that the meta information for the model used by other UEs (e.g., UE 2 822) is also updated accordingly. In some examples, the base station 804 may communicate network node information (e.g., PCIs, beam index values, and associated IDs) to the network entity 806 via 816.

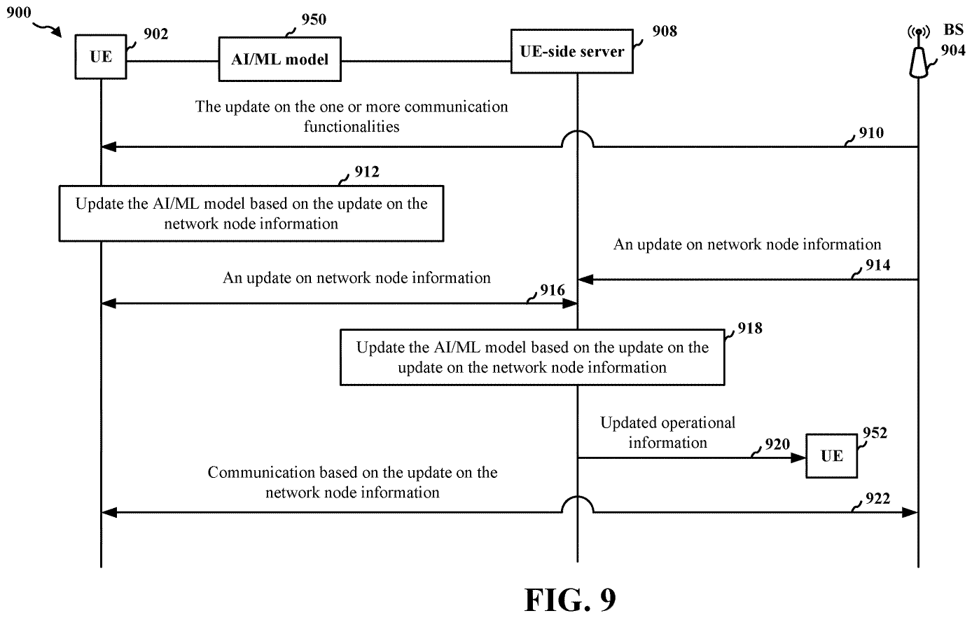

FIG. 9 is a call flow diagram 900 illustrating a method of wireless communication in accordance with various aspects of this present disclosure. Various aspects are described in connection with a UE 902, a UE-side server 908, and a base station 904. The aspects may be performed by the UE 902 or the base station 904 in aggregation and/or by one or more components of a base station 904 (e.g., a CU 110, a DU 130, and/or an RU 140). In some examples, the UE 902 may include or be associated with an AI/ML model 950. In some examples, the UE-side server 908 may include or be associated with the AI/ML model 950. For example, the AI/ML model 950 may include any of the aspects described in connection with the ANN 400 or the ML architecture 500.

As shown in FIG. 9, at 910, the UE 902 may receive from base station 904 an update on network node information related to a communication functionality for communicating between the base station 904 and the UE 902. Referring to FIG. 8, the UE 802 may receive, via 810, from base station 804 an update on network node information related to a communication functionality for communicating between the base station 804 and the UE 802. For example, the network node information includes a set of identifiers (e.g., PCIs) for cells or beams associated with the base station 904. For example, the network node information may include one or more of: a first set of cell identifiers (e.g., PCIs) for the cells associated with the base station 904, a second set of beam identifiers for the beams associated with the base station 904, or a third set of associated identifiers representing network-side conditions for the communication functionality. For example, the communication functionality may be associated with the AI/ML model 950, and the update on the network node information may include the update on the network node information from first network node information associated with the training phase of the AI/ML model 950 to second network node information associated with the inference phase of the AI/ML model 950 for the communication functionality.

In some examples, at 912, the UE 902 may update the AI/ML model 950 based on the update on the network node information. In some examples, the update on the AI/ML model 950 may be based on the update on network node information received at 910. For example, the update may ensure consistency between the training and inference phases of the AI/ML model 950.

In some examples, at 914, the UE-side server 908 may receive from base station 904 an update on network node information related to a communication functionality for communicating between the base station 904 and the UE 902. For example, referring to FIG. 7, the UE-side server 708 may receive from network entity 706 an update on network node information (e.g., PCIs, beam index values, and associated IDs) related to a communication functionality for communicating between the network entity 706 and the UE 702.

In some examples, at 916, the UE-side server 908 may receive from UE 902 an update on network node information related to a communication functionality for communicating between the base station 904 and the UE 902. For example, referring to FIG. 8, the UE-side server 808 may receive from UE 1 802, via 812, an update on network node information (e.g., PCIs, beam index values, and associated IDs) related to a communication functionality for communicating between the base station 804 and UE 1 802.

In some examples, at 916, the UE-side server 908 may transmit to UE 902 an update on network node information related to a communication functionality for communicating between the base station 904 and the UE 902. For example, referring to FIG. 7, after the UE-side server 708 received the update on network node information from network entity 706 (e.g., via 712), the UE-side server 708 may transmit to UE 702 the update on network node information (e.g., via 714).

In some examples, at 918, the UE-side server 908 may update the AI/ML model 950 based on the update on the network node information. For example, the update may ensure consistency between the training and inference phases of the AI/ML model 950.

In some examples, at 920, after updating the AI/ML model 950, the UE-side server 908 may transmit updated operation information (e.g., updated AI/ML model 950) to other UEs (e.g., UE 952) associated with the UE-side server 908. For example, referring to FIG. 8, the UE-side server 808 may transmit the revised meta information for the model to one or more UEs (e.g., UE 1 802 via 812, UE 2 822 via 814) associated with the UE-side server 808.

At 922, the base station 904 and UE 902 may communicate based on the update on the network node information. For example, the base station 904 and UE 902 may communicate based on updated AI/ML model 950, and the AI/ML model 950 may be updated based on the update on the network node information.

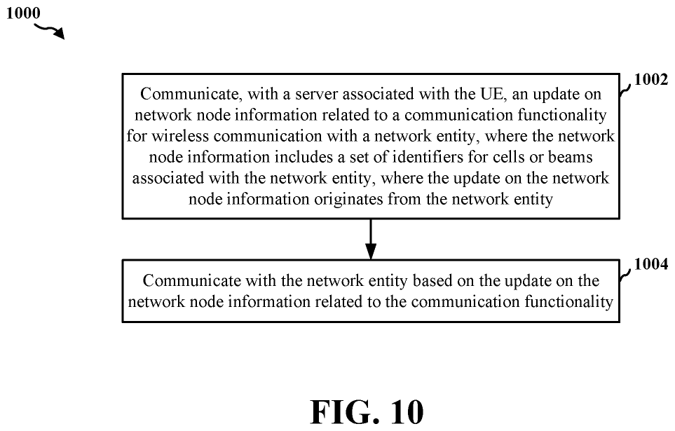

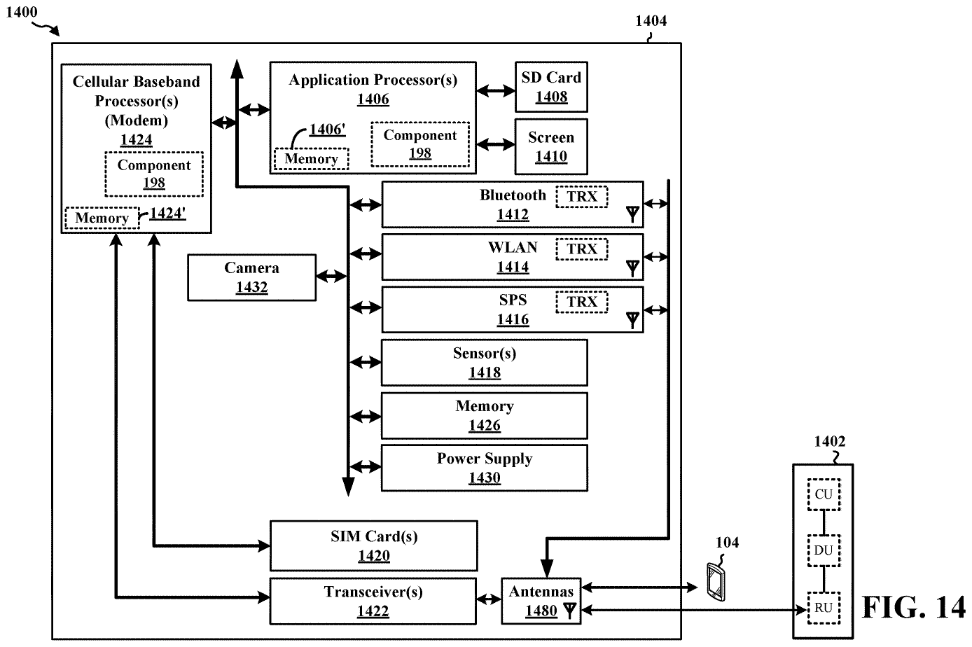

FIG. 10 is a flowchart 1000 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 704, 804, 904; or the network entity 1402 in the hardware implementation of FIG. 14). The UE may be the UE 104, 350, 702, 902, UE 1 802, or the apparatus 1404 in the hardware implementation of FIG. 14. By enabling the sharing of updated network node information, such as PCI, beam index, and associated IDs, from the network to the UE or UE-side servers, the methods ensure consistency between the training and inference phases of a model used in wireless communication systems, thereby ensuring model reliability, robustness, and adaptability in dynamic network environments. Additionally, by enabling a model update propagation mechanism from a single UE to other associated UEs via a UE-side server, the methods enhance efficiency and reduce overhead on individual UEs while maintaining consistency across devices.

As shown in FIG. 10, at 1002, the UE may communicate with a server associated with the UE an update on network node information related to a communication functionality for wireless communication with a network entity. The network node information may include a set of identifiers for cells or beams associated with the network entity, and the update on the network node information may originate from the network entity. FIG. 7, FIG. 8, and FIG. 9 illustrate various aspects of the steps in connection with flowchart 1000. For example, referring to FIG. 9, the UE 902 may, at 916, communicate with a server associated with the UE (e.g., UE-side server 908) an update on network node information related to a communication functionality for wireless communication with a network entity (e.g., base station 904). The network node information may include a set of identifiers for cells or beams associated with the network entity (e.g., base station 904), and the update on the network node information may originate from the network entity (e.g., base station 904). In some aspects, 1002 may be performed by the information sharing component 198.

At 1004, the UE may communicate with the network entity based on the update on the network node information related to the communication functionality. For example, referring to FIG. 9, the UE 902 may, at 922, communicate with the network entity (e.g., base station 904) based on the update on the network node information related to the communication functionality. In some aspects, 1004 may be performed by the information sharing component 198.

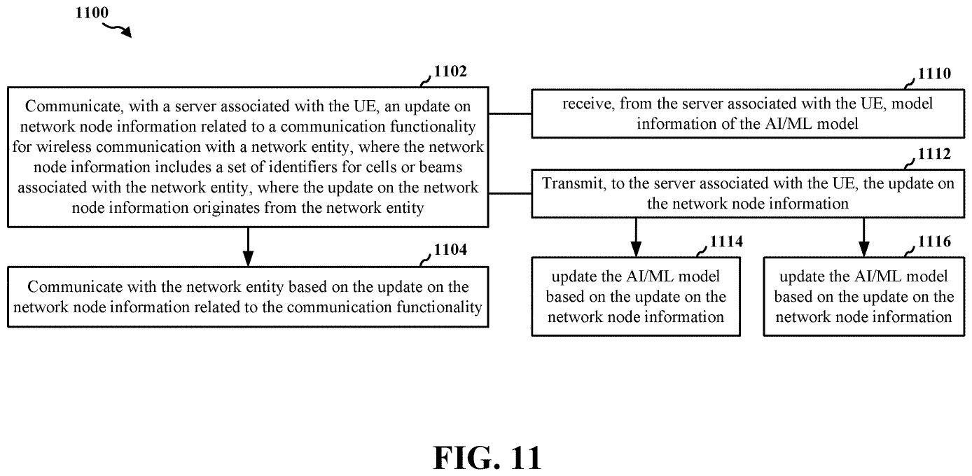

FIG. 11 is a flowchart 1100 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 704, 804, 904; or the network entity 1402 in the hardware implementation of FIG. 14). The UE may be the UE 104, 350, 702, 902, UE 1 802, or the apparatus 1404 in the hardware implementation of FIG. 14. By enabling the sharing of updated network node information, such as PCI, beam index, and associated IDs, from the network to the UE or UE-side servers, the methods ensure consistency between the training and inference phases of a model used in wireless communication systems, thereby ensuring model reliability, robustness, and adaptability in dynamic network environments. Additionally, by enabling a model update propagation mechanism from a single UE to other associated UEs via a UE-side server, the methods enhance efficiency and reduce overhead on individual UEs while maintaining consistency across devices.

As shown in FIG. 11, at 1102, the UE may communicate, with a server associated with the UE, an update on network node information related to a communication functionality for wireless communication with a network entity. The network node information may include a set of identifiers for cells or beams associated with the network entity, and the update on the network node information may originate from the network entity. FIG. 7, FIG. 8, and FIG. 9 illustrate various aspects of the steps in connection with flowchart 1100. For example, referring to FIG. 9, the UE 902 may, at 916, communicate with a server associated with the UE (e.g., UE-side server 908) an update on network node information related to a communication functionality for wireless communication with a network entity (e.g., base station 904). The network node information may include a set of identifiers for cells or beams associated with the network entity (e.g., base station 904), and the update on the network node information may originate from the network entity (e.g., base station 904). In some aspects, 1102 may be performed by the information sharing component 198.

At 1104, the UE may communicate with the network entity based on the update on the network node information related to the communication functionality. For example, referring to FIG. 9, the UE 902 may, at 922, communicate with the network entity (e.g., base station 904) based on the update on the network node information related to the communication functionality. In some aspects, 1104 may be performed by the information sharing component 198.

In some aspects, the network node information may include one or more of: a first set of cell identifiers for the cells associated with the network entity, a second set of beam identifiers for the beams associated with the network entity, or a third set of associated identifiers for network-side conditions for the communication functionality. For example, referring to FIG. 9, the network node information (e.g., at 916) may include one or more of: a first set of cell identifiers for the cells associated with the network entity (e.g., base station 904), a second set of beam identifiers for the beams associated with the network entity (e.g., base station 904), or a third set of associated identifiers for network-side conditions for the communication functionality.

In some aspects, the communication functionality may include one or more of: the spatial domain beam prediction, the temporal domain beam prediction, the measurement event prediction, the RLF prediction, or the HOF prediction. For example, referring to FIG. 9, the communication functionality (e.g., the communication functionality associated with the update on the network node information at 916) may include one or more of: the spatial domain beam prediction (e.g., via AI/ML model 950), the temporal domain beam prediction (e.g., via AI/ML model 950), the measurement event prediction (e.g., via AI/ML model 950), the RLF prediction (e.g., via AI/ML model 950), or the HOF prediction (e.g., via AI/ML model 950).

In some aspects, the communication functionality may be associated with an AI/ML model. The update on the network node information may include the update on the network node information from first network node information associated a training of the AI/ML model for the communication functionality to second network node information associated with an inference of the AI/ML model for the communication functionality. For example, referring to FIG. 9, the communication functionality may be associated with an AI/ML model 950. The update on the network node information (e.g., at 916) may include the update on the network node information from first network node information associated with the training of the AI/ML model 950 for the communication functionality to second network node information associated with the inference of the AI/ML model 950 for the communication functionality.

In some aspects, to communicate the update on the network node information (e.g., at 1102), the UE may, at 1110, receive from the server associated with the UE model information of the AI/ML model, and the model information may be based on the update on the network node information. For example, referring to FIG. 7, the UE 702 may, via 714, receive from the server (e.g., UE-side server 708) associated with the UE model information of the AI/ML model, and the model information may be based on the update on the network node information. In some aspects, 1110 may be performed by the information sharing component 198.

In some aspects, to communicate with the network entity based on the update on the network node information (e.g., at 1104), the UE may communicate with the network entity based on the model information of the AI/ML model. For example, referring to FIG. 9, the UE 902 may, at 922, communicate with the network entity (e.g., base station 904) based on the model information of the AI/ML model 950.

In some aspects, the update on the network node information may originate from a serving cell associated with the network entity. For example, referring to FIG. 9, the update on the network node information may originate from a serving cell associated with the network entity (e.g., base station 904). Referring to FIG. 7, the update on the network node information may originate from a serving cell (e.g., 704) associated with the network entity 706.

In some aspects, to communicate the update on the network node information (e.g., at 1102), the UE may, at 1112, transmit to the server associated with the UE the update on the network node information. For example, referring to FIG. 8, the UE 802 may, via 812, transmit to the server (e.g., UE-side server 808) associated with the UE the update on the network node information. In some aspects, 1112 may be performed by the information sharing component 198.

In some aspects, at 1114, the UE may update the AI/ML model based on the update on the network node information. For example, referring to FIG. 9, the UE 902 may, at 912, update the AI/ML model 950 based on the update on the network node information. In some aspects, 1114 may be performed by the information sharing component 198.

In some aspects, at 1116, the UE may receive, from a serving cell associated with the network entity, the update on the one or more communication functionalities. For example, referring to FIG. 9, the UE 902 may, at 910, receive, from a serving cell associated with the network entity (e.g., base station 904), the update on the one or more communication functionalities. Referring to FIG. 8, the UE (e.g., UE 1 802) may, via 810, receive, from a serving cell associated with the network entity (e.g., base station 804), the update on the one or more communication functionalities. In some aspects, 1116 may be performed by the information sharing component 198.

In some aspects, the first set of cell identifiers for the cell may include a set of PCI for the cell.

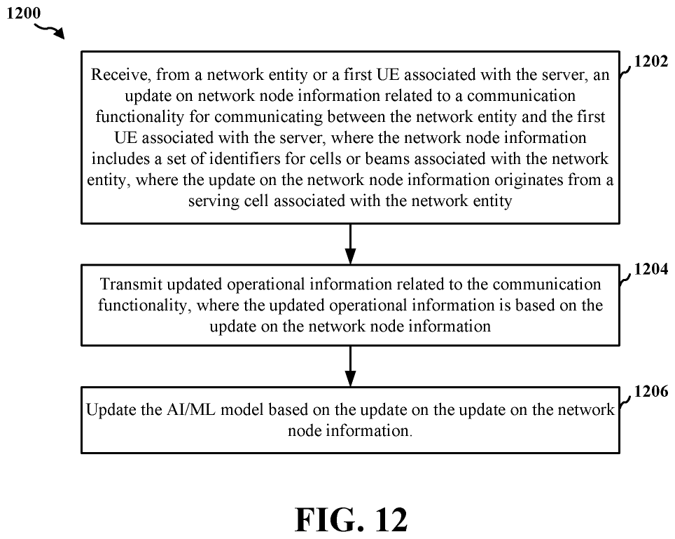

FIG. 12 is a flowchart 1200 illustrating methods of wireless communication at a server associated with one or more UEs in accordance with various aspects of the present disclosure. The method may be performed by the server in collaboration with a UE and a network entity. The network entity may be a base station, or a component of a base station, in the access network of FIG. 1 or a core network component (e.g., base station 102, 310, 704, 804, 904; or the network entity 1402 in the hardware implementation of FIG. 14). The UE may be the UE 104, 350, 702, 902, UE 1 802 or the apparatus 1404 in the hardware implementation of FIG. 14. The server may be UE-side server 708, 808, 908. By enabling the sharing of updated network node information, such as PCI, beam index, and associated IDs, from the network to the UE or UE-side servers, the methods ensure consistency between the training and inference phases of a model used in wireless communication systems, thereby ensuring model reliability, robustness, and adaptability in dynamic network environments. Additionally, by enabling a model update propagation mechanism from a single UE to other associated UEs via a UE-side server, the methods enhance efficiency and reduce overhead on individual UEs while maintaining consistency across devices.

As shown in FIG. 12, at 1202, the server may receive, from a network entity or a first UE associated with the server, an update on network node information related to a communication functionality for communicating between the network entity and the first UE associated with the server. The network node information may include a set of identifiers for cells or beams associated with the network entity, and the update on the network node information originates from a serving cell associated with the network entity. FIG. 7, FIG. 8, and FIG. 9 illustrate various aspects of the steps in connection with flowchart 1200. For example, referring to FIG. 9, the server (e.g., the UE-side server 908) may, at 914 or 916, receive from a network entity (e.g., base station 904) or a first UE (e.g., UE 902) associated with the server, an update on network node information related to a communication functionality for communicating between the network entity (e.g., base station 904) and the first UE (e.g., UE 902) associated with the server. The network node information may include a set of identifiers for cells or beams associated with the network entity, and the update on the network node information originates from a serving cell associated with the network entity (e.g., base station 904). In some aspects, 1202 may be performed by the information sharing component 199.

At 1204, the server may transmit updated operational information related to the communication functionality. The updated operational information is based on the update on the network node information. For example, referring to FIG. 7, the server (e.g., UE-side server 708) may transmit, via 714, updated operational information related to the communication functionality to UE 702. Referring to FIG. 8, the server (e.g., UE-side server 808) may transmit, via 814, updated operational information related to the communication functionality to UE 2 822. The updated operational information is based on the update on the network node information. In some aspects, 1204 may be performed by the information sharing component 199.

In some aspects, the network node information may include one or more of: a first set of cell identifiers for the cells associated with the network entity, a second set of beam identifiers for the beams associated with the network entity, or a third set of associated identifiers representing network-side conditions for the communication functionality. For example, referring to FIG. 9, the network node information (e.g., at 914 or 916) may include one or more of: a first set of cell identifiers for the cells associated with the network entity, a second set of beam identifiers for the beams associated with the network entity, or a third set of associated identifiers representing network-side conditions for the communication functionality.

In some aspects, the communication functionality may be associated with an AI/ML model. The update on the network node information includes the update on the network node information from first network node information associated a training of the AI/ML model for the communication functionality to second network node information associated with an inference of the AI/ML model for the communication functionality, and the updated operational information related to the communication functionality includes a model update to the AI/ML model. For example, referring to FIG. 9, the communication functionality may be associated with an AI/ML model 950. The update on the network node information includes the update on the network node information from first network node information associated with the training of the AI/ML model 950 to second network node information associated with an inference of the AI/ML model 950, and the updated operational information related to the communication functionality includes a model update to the AI/ML model 950.

In some aspects, at 1206, the server may update the AI/ML model based on the update on the network node information. For example, referring to FIG. 9, the server (e.g., UE-side server 908) may, at 918, update the AI/ML model 950 based on the update on the network node information. In some aspects, 1206 may be performed by the information sharing component 199.

In some aspects, the server may include one or more of: an over-the-top (OTT) device associated with the first UE, an application function (AF) associated with the first UE, a non-real-time application (rApp) associated with the first UE, or a near-real-time application (xApp) associated with the first UE. For example, referring to FIG. 9, the server (e.g., UE-side server 908) may include one or more of: an OTT device associated with the first UE (e.g., UE 902), an AF associated with the first UE (e.g., UE 902), an rApp associated with the first UE (e.g., UE 902), or an xApp associated with the first UE (e.g., UE 902).

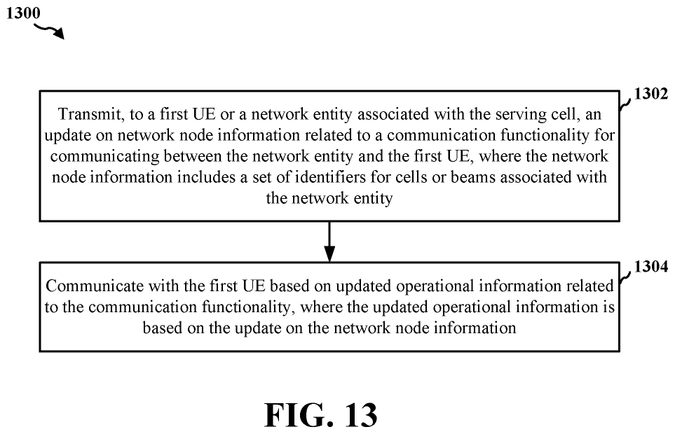

FIG. 13 is a flowchart 1300 illustrating methods of wireless communication at a serving cell in accordance with various aspects of the present disclosure. The method may be performed by the serving cell in collaboration with a UE and a UE-side server. The serving cell may be associated with a network entity. The network entity may be a base station, or a component of a base station, in the access network of FIG. 1 or a core network component (e.g., base station 102, 310, 704, 804, 904; or the network entity 1402 in the hardware implementation of FIG. 14). The UE may be the UE 104, 350, 702, 802, 902, or the apparatus 1404 in the hardware implementation of FIG. 14.

The UE-side server may be UE-side server 708, 808, 908. By enabling the sharing of updated network node information, such as PCI, beam index, and associated IDs, from the network to the UE or UE-side servers, the methods ensure consistency between the training and inference phases of a model used in wireless communication systems, thereby ensuring model reliability, robustness, and adaptability in dynamic network environments. Additionally, by enabling a model update propagation mechanism from a single UE to other associated UEs via a UE-side server, the methods enhance efficiency and reduce overhead on individual UEs while maintaining consistency across devices.

As shown in FIG. 13, at 1302, the serving cell may transmit, to a first UE or a network entity associated with the serving cell, an update on network node information related to a communication functionality for communicating between the network entity and the first UE. The network node information includes a set of identifiers for cells or beams associated with the network entity. FIG. 7, FIG. 8, and FIG. 9 illustrate various aspects of the steps in connection with flowchart 1300. For example, referring to FIG. 7 and FIG. 8, the serving cell (e.g., 704, 804) may, via 710 or 810, transmit, to a first UE (e.g., UE 1 802) or a network entity (e.g., network entity 706) associated with the serving cell, an update on network node information related to a communication functionality for communicating between the network entity and the first UE. The network node information includes a set of identifiers for cells or beams associated with the network entity. In some aspects, 1302 may be performed by the information sharing component 199.

At 1304, the serving cell may communicate with the first UE based on updated operational information related to the communication functionality. The updated operational information may be based on the update on the network node information. For example, referring to FIG. 9, the serving cell (e.g., base station 904) may, at 922, communicate with the first UE (e.g., UE 902) based on updated operational information related to the communication functionality. The updated operational information may be based on the update on the network node information. In some aspects, 1304 may be performed by the information sharing component 199.

In some aspects, the network node information may include one or more of: a first set of cell identifiers for the cells associated with the network entity, a second set of beam identifiers for the beams associated with the network entity, or a third set of associated identifiers representing network-side conditions for the communication functionality. For example, referring to FIG. 9, the network node information (e.g., at 914) may include one or more of: a first set of cell identifiers for the cells associated with the network entity (e.g., base station 904), a second set of beam identifiers for the beams associated with the network entity (e.g., base station 904), or a third set of associated identifiers representing network-side conditions for the communication functionality.

In some aspects, the communication functionality is associated with an AI/ML model. The update on the network node information may include the update on the network node information from first network node information associated a training of the AI/ML model for the communication functionality to second network node information associated with an inference of the AI/ML model for the communication functionality, and the updated operational information related to the communication functionality includes a model update to the AI/ML model. For example, referring to FIG. 9, the communication functionality is associated with an AI/ML model 950. The update on the network node information may include the update on the network node information from first network node information associated a training of the AI/ML model 950 to second network node information associated with an inference of the AI/ML model 950, and the updated operational information related to the communication functionality includes a model update to the AI/ML model 950.

In some aspects, to transmit the update on the network node information (e.g., at 1302), the serving cell may transmit, to the first UE, during a configuration for the inference of the AI/ML model at the first UE, the update on the network node information. For example, referring to FIG. 9, the serving cell (e.g., base station 904) may, at 910, transmit, to the first UE (e.g., UE 902), during a configuration for the inference of the AI/ML model 950 at the first UE (e.g., UE 902), the update on the network node information.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor (or processing circuitry) 1424 (also referred to as a modem) coupled to one or more transceivers 1422 (e.g., cellular RF transceiver). The cellular baseband processor(s) (or processing circuitry) 1424 may include at least one on-chip memory (or memory circuitry) 1424′. In some aspects, the apparatus 1404 may further include one or more subscriber identity modules (SIM) cards 1420 and at least one application processor (or processing circuitry) 1406 coupled to a secure digital (SD) card 1408 and a screen 1410. The application processor(s) (or processing circuitry) 1406 may include on-chip memory (or memory circuitry) 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) (or processing circuitry) 1424 communicates through the transceiver(s) 1422 via one or more antennas 1480 with the UE 104 and/or with an RU associated with a network entity 1402. The cellular baseband processor(s) (or processing circuitry) 1424 and the application processor(s) (or processing circuitry) 1406 may each include a computer-readable medium/memory (or memory circuitry) 1424′, 1406′, respectively. The additional memory modules 1426 may also be considered a computer-readable medium/memory (or memory circuitry). Each computer-readable medium/memory (or memory circuitry) 1424′, 1406′, 1426 may be non-transitory. The cellular baseband processor(s) (or processing circuitry) 1424 and the application processor(s) (or processing circuitry) 1406 are each responsible for general processing, including the execution of software stored on the computer-readable medium/memory (or memory circuitry). The software, when executed by the cellular baseband processor(s) (or processing circuitry) 1424/application processor(s) (or processing circuitry) 1406, causes the cellular baseband processor(s) (or processing circuitry) 1424/application processor(s) (or processing circuitry) 1406 to perform the various functions described supra. The cellular baseband processor(s) (or processing circuitry) 1424 and the application processor(s) (or processing circuitry) 1406 are configured to perform the various functions described supra based at least in part of the information stored in the memory (or memory circuitry). That is, the cellular baseband processor(s) (or processing circuitry) 1424 and the application processor(s) (or processing circuitry) 1406 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1424/application processor(s) (or processing circuitry) 1406 when executing software. The cellular baseband processor(s) (or processing circuitry) 1424/application processor(s) (or processing circuitry) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) (or processing circuitry) 1424 and/or the application processor(s) (or processing circuitry) 1406, and in another configuration, the apparatus 1404 may be the entire UE (e.g., see UE 350 of FIG. 3) and include the additional modules of the apparatus 1404.

As discussed supra, the component 198 may be configured to communicate, with a server associated with the UE, an update on network node information related to a communication functionality for wireless communication with a network entity, where the network node information includes a set of identifiers for cells or beams associated with the network entity, where the update on the network node information originates from the network entity; and communicate with the network entity based on the update on the network node information related to the communication functionality. The component 198 may be further configured to perform any of the aspects described in connection with the flowcharts in FIG. 10 and FIG. 11, and/or performed by the UE 902 in FIG. 9. The component 198 may be within the cellular baseband processor(s) (or processing circuitry) 1424, the application processor(s) (or processing circuitry) 1406, or both the cellular baseband processor(s) (or processing circuitry) 1424 and the application processor(s) (or processing circuitry) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) (or processing circuitry) 1424 and/or the application processor(s) (or processing circuitry) 1406, includes means for communicating, with a server associated with the UE, an update on network node information related to a communication functionality for wireless communication with a network entity, where the network node information includes a set of identifiers for cells or beams associated with the network entity, where the update on the network node information originates from the network entity; and means for communicating with the network entity based on the update on the network node information related to the communication functionality. The apparatus 1404 may further include means for performing any of the aspects described in connection with the flowcharts in FIG. 10 and FIG. 11, and/or aspects performed by the UE 902 in FIG. 9. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

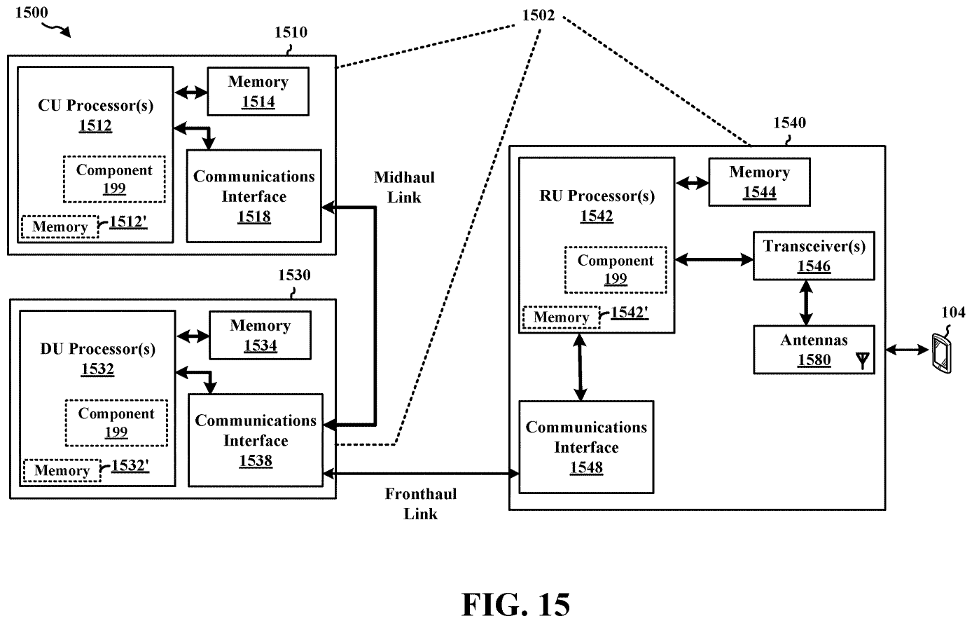

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor (or processing circuitry) 1512. The CU processor(s) (or processing circuitry) 1512 may include on-chip memory (or memory circuitry) 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor (or processing circuitry) 1532. The DU processor(s) (or processing circuitry) 1532 may include on-chip memory (or memory circuitry) 1532′. In some aspects, the DU 1530 may further include additional memory modules 1534 and a communications interface 1538. The DU 1530 communicates with the RU 1540 through a fronthaul link. The RU 1540 may include at least one RU processor (or processing circuitry) 1542. The RU processor(s) (or processing circuitry) 1542 may include on-chip memory (or memory circuitry) 1542′. In some aspects, the RU 1540 may further include additional memory modules 1544, one or more transceivers 1546, antennas 1580, and a communications interface 1548. The RU 1540 communicates with the UE 104. The on-chip memory (or memory circuitry) 1512′, 1532′, 1542′ and the additional memory modules 1514, 1534, 1544 may each be considered a computer-readable medium/memory (or memory circuitry). Each computer-readable medium/memory (or memory circuitry) may be non-transitory. Each of the processors (or processing circuitry) 1512, 1532, 1542 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, to a first UE or a network entity associated with the serving cell, an update on network node information related to a communication functionality for communicating between the network entity and the first UE, where the network node information includes a set of identifiers for cells or beams associated with the network entity; and communicate with the first UE based on updated operational information related to the communication functionality. The updated operational information is based on the update on the network node information. The component 199 may be further configured to perform any of the aspects described in connection with the flowcharts in FIG. 12 and FIG. 13, and/or performed by the base station 904 in FIG. 9. The component 199 may be within one or more processors (or processing circuitry) of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 includes means for transmitting, to a first UE or a network entity associated with the serving cell, an update on network node information related to a communication functionality for communicating between the network entity and the first UE, where the network node information includes a set of identifiers for cells or beams associated with the network entity; and means for communicating with the first UE based on updated operational information related to the communication functionality. The updated operational information is based on the update on the network node information. The network entity 1502 may further include means for performing any of the aspects described in connection with the flowcharts in FIG. 12 and FIG. 13, and/or aspects performed by the base station 904 in FIG. 9. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include communicating, with a server associated with the UE, an update on network node information related to a communication functionality for wireless communication with a network entity, where the network node information includes a set of identifiers for cells or beams associated with the network entity, where the update on the network node information originates from the network entity; and communicating with the network entity based on the update on the network node information related to the communication functionality. By enabling the sharing of updated network node information, such as PCI, beam index, and associated IDs, from the network to the UE or UE-side servers, the methods ensure consistency between the training and inference phases of a model used in wireless communication systems, thereby ensuring model reliability, robustness, and adaptability in dynamic network environments. Additionally, by enabling a model update propagation mechanism from a single UE to other associated UEs via a UE-side server, the methods enhance efficiency and reduce overhead on individual UEs while maintaining consistency across devices.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a user equipment (UE). The method includes communicating, with a server associated with the UE, an update on network node information related to a communication functionality for wireless communication with a network entity, wherein the network node information includes a set of identifiers for cells or beams associated with the network entity, wherein the update on the network node information originates from the network entity; and communicating with the network entity based on the update on the network node information related to the communication functionality.

Aspect 2 is the method of aspect 1, wherein the network node information includes one or more of: a first set of cell identifiers for the cells associated with the network entity; a second set of beam identifiers for the beams associated with the network entity; or a third set of associated identifiers for network-side conditions for the communication functionality.

Aspect 3 is the method of any of aspects 1 to 2, wherein the communication functionality includes one or more of: a spatial domain beam prediction; a temporal domain beam prediction; a measurement event prediction; a radio link failure (RLF) prediction; or a handover failure (HOF) prediction.

Aspect 4 is the method of any of aspects 1 to 3, wherein the communication functionality is associated with an artificial intelligent/machine learning (AI/ML) model, wherein the update on the network node information includes the update on the network node information from first network node information associated a training of the AI/ML model for the communication functionality to second network node information associated with an inference of the AI/ML model for the communication functionality.

Aspect 5 is the method of aspect 4, wherein communicating the update on the network node information comprises receiving, from the server associated with the UE, model information of the AI/ML model, wherein the model information is based on the update on the network node information.

Aspect 6 is the method of aspect 5, wherein communicating with the network entity based on the update on the network node information comprises communicating with the network entity based on the model information of the AI/ML model.

Aspect 7 is the method of aspect 5, wherein the update on the network node information originates from a serving cell associated with the network entity.

Aspect 8 is the method of aspect 4, wherein communicating the update on the network node information comprises transmitting, to the server associated with the UE, the update on the network node information.

Aspect 9 is the method of aspect 8, where the method further includes updating the AI/ML model based on the update on the network node information.

Aspect 10 is the method of aspect 8, where the method further includes receiving, from a serving cell associated with the network entity, the update on the one or more communication functionalities.

Aspect 11 is the method of any of aspects 1 to 2, wherein the first set of cell identifiers for the cell includes a set of physical cell identifiers (PCI) for the cell.

Aspect 12 is an apparatus for wireless communication at a UE, comprising: at least one memory; and at least one processor coupled to the at least one memory, the at least one processor is configured to perform the method of any of aspects 1 to 11.

Aspect 13 is the apparatus for wireless communication at a UE, comprising means for performing each step in the method of any of aspects 1-11.

Aspect 14 is an apparatus of any of aspects 12-13, further comprising a transceiver configured to receive or to transmit in association with the method of any of aspects 1-11.

Aspect 15 is a computer-readable medium (e.g., a non-transitory computer-readable medium) storing computer executable code at a UE, the code when executed by at least one processor causes the at least one processor to perform the method of any of aspects 1-11.

Aspect 16 is a method of wireless communication at a server associated with one or more user equipment (UEs). The method includes receiving, from a network entity or a first UE associated with the server, an update on network node information related to a communication functionality for communicating between the network entity and the first UE associated with the server, wherein the network node information includes a set of identifiers for cells or beams associated with the network entity, wherein the update on the network node information originates from a serving cell associated with the network entity; and transmitting updated operational information related to the communication functionality, wherein the updated operational information is based on the update on the network node information.

Aspect 17 is the method of aspect 16, wherein the network node information includes one or more of: a first set of cell identifiers for the cells associated with the network entity; a second set of beam identifiers for the beams associated with the network entity; or a third set of associated identifiers representing network-side conditions for the communication functionality.

Aspect 18 is the method of aspect 17, wherein the communication functionality is associated with an artificial intelligent/machine learning (AI/ML) model, wherein the update on the network node information includes the update on the network node information from first network node information associated a training of the AI/ML model for the communication functionality to second network node information associated with an inference of the AI/ML model for the communication functionality, and wherein the updated operational information related to the communication functionality includes a model update to the AI/ML model.

Aspect 19 is the method of aspect 18, where the method further includes updating the AI/ML model based on the update on the network node information.

Aspect 20 is the method of aspect 16, wherein the server includes one or more of: an over-the-top (OTT) device associated with the first UE; an application function (AF) associated with the first UE; a non-real-time application (rApp) associated with the first UE; or a near-real-time application (xApp) associated with the first UE.

Aspect 21 is an apparatus for wireless communication at a server associated with one or more UEs, comprising: at least one memory; and at least one processor coupled to the at least one memory and, where the at least one processor is configured to perform the method of any of aspects 16-20.

Aspect 22 is the apparatus for wireless communication at a server associated with one or more UEs, comprising means for performing each step in the method of any of aspects 16-20.

Aspect 23 is an apparatus of any of aspects 21-22, further comprising a transceiver configured to receive or to transmit in association with the method of any of aspects 16-20.

Aspect 24 is a computer-readable medium (e.g., a non-transitory computer-readable medium) storing computer executable code at a server associated with one or more UEs, the code when executed by at least one processor causes the at least one processor to perform the method of any of aspects 16-20.

Aspect 25 is a method of wireless communication at a serving cell. The method includes transmitting, to a first user equipment (UE) or a network entity associated with the serving cell, an update on network node information related to a communication functionality for communicating between the network entity and the first UE, wherein the network node information includes a set of identifiers for cells or beams associated with the network entity; and communicating with the first UE based on updated operational information related to the communication functionality, wherein the updated operational information is based on the update on the network node information.

Aspect 26 is the method of aspect 25, wherein the network node information includes one or more of: a first set of cell identifiers for the cells associated with the network entity; a second set of beam identifiers for the beams associated with the network entity; or a third set of associated identifiers representing network-side conditions for the communication functionality.

Aspect 27 is the method of aspect 26, wherein the communication functionality is associated with an artificial intelligent/machine learning (AI/ML) model, wherein the update on the network node information includes the update on the network node information from first network node information associated a training of the AI/ML model for the communication functionality to second network node information associated with an inference of the AI/ML model for the communication functionality, and wherein the updated operational information related to the communication functionality includes a model update to the AI/ML model.

Aspect 28 is the method of aspect 27, wherein transmitting the update on the network node information comprises transmitting, to the first UE, during a configuration for the inference of the AI/ML model at the first UE, the update on the network node information.

Aspect 29 is an apparatus for wireless communication at a serving cell, comprising: at least one memory; and at least one processor coupled to the at least one memory and, where the at least one processor is configured to perform the method of any of aspects 25-28.

Aspect 30 is the apparatus for wireless communication at a serving cell, comprising means for performing each step in the method of any of aspects 25-28.

Aspect 31 is an apparatus of any of aspects 29-30, further comprising a transceiver configured to receive or to transmit in association with the method of any of aspects 25-28.

Aspect 32 is a computer-readable medium (e.g., a non-transitory computer-readable medium) storing computer executable code at a serving cell, the code when executed by at least one processor causes the at least one processor to perform the method of any of aspects 25-28.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
communicate, with a server associated with the UE, an update on network node information related to a communication functionality for wireless communication with a network entity, wherein the network node information includes a set of identifiers for cells or beams associated with the network entity, wherein the update on the network node information originates from the network entity; and
communicate with the network entity based on the update on the network node information related to the communication functionality.

2. The apparatus of claim 1, further comprising a transceiver coupled to the at least one processor, wherein to communicate the update on the network node information, the at least one processor is configured to communicate the update on the network node information via the transceiver, wherein the network node information includes one or more of:
a first set of cell identifiers for the cells associated with the network entity,
a second set of beam identifiers for the beams associated with the network entity, or
a third set of associated identifiers for network-side conditions for the communication functionality.

3. The apparatus of claim 2, wherein the communication functionality includes one or more of:
a spatial domain beam prediction,
a temporal domain beam prediction,
a measurement event prediction,
a radio link failure (RLF) prediction, or
a handover failure (HOF) prediction.

4. The apparatus of claim 2, wherein the communication functionality is associated with an artificial intelligent/machine learning (AI/ML) model, wherein the update on the network node information includes the update on the network node information from first network node information associated a training of the AI/ML model for the communication functionality to second network node information associated with an inference of the AI/ML model for the communication functionality.

5. The apparatus of claim 4, wherein to communicate the update on the network node information, the at least one processor is configured to:
receive, from the server associated with the UE, model information of the AI/ML model, wherein the model information is based on the update on the network node information.

6. The apparatus of claim 5, wherein to communicate with the network entity based on the update on the network node information, the at least one processor is configured to:
communicate with the network entity based on the model information of the AI/ML model.

7. The apparatus of claim 5, wherein the update on the network node information originates from a serving cell associated with the network entity.

8. The apparatus of claim 4, wherein to communicate the update on the network node information, the at least one processor is configured to:
transmit, to the server associated with the UE, the update on the network node information.

9. The apparatus of claim 8, wherein the at least one processor is further configured to:
update the AI/ML model based on the update on the network node information.

10. The apparatus of claim 8, wherein the at least one processor is further configured to:
receive, from a serving cell associated with the network entity, the update on the one or more communication functionalities.

11. The apparatus of claim 2, wherein the first set of cell identifiers for the cell includes a set of physical cell identifiers (PCI) for the cell.

12. An apparatus for wireless communication at a server associated with one or more user equipment (UEs), comprising:
at least one memory; and
at least one processor coupled to the at least one memory and, based at least in part on information stored in the at least one memory, the at least one processor is configured to:
receive, from a network entity or a first UE associated with the server, an update on network node information related to a communication functionality for communicating between the network entity and the first UE associated with the server, wherein the network node information includes a set of identifiers for cells or beams associated with the network entity, wherein the update on the network node information originates from a serving cell associated with the network entity; and
transmit updated operational information related to the communication functionality, wherein the updated operational information is based on the update on the network node information.

13. The apparatus of claim 12, further comprising a transceiver coupled to the at least one processor, wherein to receive the update on the network node information, the at least one processor is configured to receive the update on the network node information via the transceiver, wherein the network node information includes one or more of:
a first set of cell identifiers for the cells associated with the network entity,
a second set of beam identifiers for the beams associated with the network entity, or
a third set of associated identifiers representing network-side conditions for the communication functionality.

14. The apparatus of claim 13, wherein the communication functionality is associated with an artificial intelligent/machine learning (AI/ML) model, wherein the update on the network node information includes the update on the network node information from first network node information associated a training of the AI/ML model for the communication functionality to second network node information associated with an inference of the AI/ML model for the communication functionality, and wherein the updated operational information related to the communication functionality includes a model update to the AI/ML model.

15. The apparatus of claim 14, wherein the at least one processor is further configured to:
update the AI/ML model based on the update on the network node information.

16. The apparatus of claim 12, wherein the server includes one or more of:
an over-the-top (OTT) device associated with the first UE,
an application function (AF) associated with the first UE,
a non-real-time application (rApp) associated with the first UE, or
a near-real-time application (xApp) associated with the first UE.

17. An apparatus for wireless communication at a serving cell, comprising:
at least one memory; and
at least one processor coupled to the at least one memory and, based at least in part on information stored in the at least one memory, the at least one processor is configured to:
transmit, to a first user equipment (UE) or a network entity associated with the serving cell, an update on network node information related to a communication functionality for communicating between the network entity and the first UE, wherein the network node information includes a set of identifiers for cells or beams associated with the network entity; and
communicate with the first UE based on updated operational information related to the communication functionality, wherein the updated operational information is based on the update on the network node information.

18. The apparatus of claim 17, further comprising a transceiver coupled to the at least one processor, wherein to transmit the update on the network node information, the at least one processor is configured to transmit the update on the network node information via the transceiver, wherein the network node information includes one or more of:
a first set of cell identifiers for the cells associated with the network entity,
a second set of beam identifiers for the beams associated with the network entity, or
a third set of associated identifiers representing network-side conditions for the communication functionality.

19. The apparatus of claim 18, wherein the communication functionality is associated with an artificial intelligent/machine learning (AI/ML) model, wherein the update on the network node information includes the update on the network node information from first network node information associated a training of the AI/ML model for the communication functionality to second network node information associated with an inference of the AI/ML model for the communication functionality, and wherein the updated operational information related to the communication functionality includes a model update to the AI/ML model.

20. The apparatus of claim 19, wherein to transmit the update on the network node information, the at least one processor is configured to:
transmit, to the first UE, during a configuration for the inference of the AI/ML model at the first UE, the update on the network node information.
